(19) United States
(12) Patent Application Publication
(10) Pub. No.: US 2013/0051058 A1
(43) Pub. Date: Feb. 28, 2013

(54) OPTICALLY ADJUSTABLE LIGHT MODULE

(71) Applicants: Zoltan Bako, Balatonalmadi (HU); Jozsef Gallai, Budapest (HU); Imre Molnar, Budapest (HU); Istvan Mudra, Szod (HU)

(72) Inventors: Zoltan Bako, Balatonalmadi (HU); Jozsef Gallai, Budapest (HU); Imre Molnar, Budapest (HU); Istvan Mudra, Szod (HU)

(73) Assignee: GENERAL ELECTRIC COMPANY, Schenectady, NY (US)

(21) Appl. No.: 13/220,985

(22) Filed: Aug. 30, 2011

(51) Int. Cl. B60Q 1/02; B60Q 1/26; F21V 7/00; F21V 21/14; F21V 21/00

(52) U.S. Cl. 362/523; 362/249.1; 362/249.02; 362/241

(57) ABSTRACT

An optically adjustable light module, such as a daytime running lamp of a motor vehicle, includes a light source (e.g., including an LED) which is rotatable about a rotational axis and has an optical axis. An arm is connected to the light source such that movement of the arm enables rotation of the light source and adjustment of the optical axis.

### FIELD OF THE INVENTION

This disclosure pertains to an optically adjustable light module and, in particular, to an optically adjustable LED light module for motor vehicles.

### BACKGROUND OF THE INVENTION

Motor vehicles include various lights that provide exterior illumination or increase visibility of the vehicle to others. These lights can include several lighting functions, among others daytime running lamps (DRLs). DRLs purposely provide lights used during daytime to alert oncoming drivers enhancing car conspicuity. Usually the DRLs are activated with the operation of the car and deactivated/dimmed to position lights when other front lighting functions are activated. Those can be incorporated in new cars, but a need exists to mount them on existing cars.

DRL light modules used in motor vehicles may have a plurality of light sources such as LEDs. The light sources are positioned/directed in such a way that the overall projected light requirements relative to the car longitudinal axis are met. This is ensured by defining an optical axis for the module, ensuring projected light requirements relative to the optical axis, and setting the optical axis parallel with the car axis during installation.

Car fronts where the DRL modules should be attached vary in shape and angle relative to the car axis. Therefore attaching DRL modules to existing cars can be difficult, as current DRL module designs feature preset optical axis—module axis angles. As a consequence different designs regarding the light module angle are needed for different car front shapes.

The DRL light module of this disclosure solves this problem in that it can be fit to existing car fronts with different shapes, the optical axis adjusted to be parallel with the car axis.

### BRIEF DESCRIPTION OF THE INVENTION

In general, this disclosure features an optically adjustable light module comprising at least one light source or lamp which is rotatable about a rotational axis and has an optical axis; and an arm that is connected to the light source such that movement of the arm enables the rotation of the light source and adjustment of the optical axis.

Referring to specific features, the light source can comprise a light emitting diode. The light source can comprise a reflector and/or lens system and a light emitting diode (and associated electronics) positioned such that light from the diode is partly reflected by the reflector and/or lens system. The light module can include a housing with heat transfer fins disposed in thermal communication with the housing, the light sources and the arm being received in the housing. A light transmitting cover can optionally be fastened to a front of the housing. A seating surface can receive a fastener at the rotational axis of the light source.

In a first specific aspect, an L-shaped bracket has a base leg and an upstanding leg. The light source is secured to the upstanding leg. A fastener disposed at the rotational axis of the light source extends between the base leg and the seating surface. The fastener at the rotational axis and a fastener between the base leg and arm enable rotation of the light source such that the optical axis is adjusted parallel with a longitudinal reference line (e.g., the longitudinal axis of a motor vehicle) when the arm is moved.

In a second specific aspect, an L-shaped bracket has a base leg and an upstanding leg. The light source is secured to the upstanding leg. A linkage plate is disposed between the seating surface and the base leg. A fastener disposed at the rotational axis of the light source extends between the base leg and the seating surface (and through the linkage plate). The fastener at the rotational axis, a fastener disposed between the base leg and the linkage plate and a fastener disposed between the linkage plate and the arm enable rotation of the light source such that the optical axis is adjusted parallel with a longitudinal reference line (e.g., the longitudinal axis of a motor vehicle) when the arm is moved.

Regarding additional specific features, a handle is rotatably mounted at a rotational axis to the seating surface, and includes a fastener between the handle and arm. Pivoting of the handle about the rotational axis moves the arm. The light module is configured and arranged to be mounted to a motor vehicle, in particular as a daytime running light for the motor vehicle. There can be at least two of the light sources, in particular, at least four of the light sources.

Referring to a second embodiment, an optically adjustable light module comprises a plurality of light sources which are each rotatable about a rotational axis and are configured and arranged to have parallel optical axes, wherein each of the light sources comprises a reflector and/or lens system and a light emitting diode positioned such that light from the light emitting diode is partially reflected by the reflector and/or lens system. An arm is rotatably connected to all of the light sources such that movement of the arm enables the rotation of the light sources and the optical axes of the light sources to be simultaneously adjusted parallel with each other. A housing receives the light sources and the arm in an interior thereof. Heat transfer fins are disposed in thermal communication with the housing. A light transmitting cover can optionally be fastened to a front of the housing.

Regarding specific features that can be used in the second embodiment, either the first or second aspects apply (pertaining to the L-shaped bracket, arm, fasteners and optional linkage plate as described above). In particular, in a first aspect L-shaped brackets in the housing each have a base leg and an upstanding leg. The light sources are secured to the upstanding legs. Fasteners at each rotational axis extend between each base leg and the housing. There are fasteners between each base leg and the arm. The fasteners at each rotational axis, and the fasteners between each base leg and the arm enable rotation of each of the light sources such that the optical axes of the light sources are simultaneously adjusted parallel with each other when the arm is moved. In a second aspect L-shaped brackets in the housing each have a base leg and an upstanding leg. The light sources are secured to the upstanding legs. Linkage plates are disposed between the housing and each base leg. Fasteners at each rotational axis extend between each base leg and the housing. Fasteners are disposed between each base leg and each linkage plate and fasteners are disposed between each linkage plate and the arm. The fasteners at each rotational axis, the fasteners between each base leg and each linkage plate, and the fasteners between each linkage plate and the arm enable rotation of each of the light sources such that the optical axes of the light sources are simultaneously adjusted parallel with each other when the arm is moved.

A handle can be rotatably mounted at a rotational axis to the seating surface, and includes a fastener between the handle and arm. The light module is configured and arranged to be mounted to a motor vehicle, in particular as a daytime running light for the motor vehicle. The plurality of light sources includes at least two of the light sources, in particular, at least four of the light sources.

Referring to a third embodiment of this disclosure, an optically adjustable light module comprises a plurality of light sources which are each rotatable about a rotational axis and are configured and arranged to have parallel optical axes, wherein each of the light sources comprises a reflector and/or lens system and a light emitting diode positioned such that light from the light emitting diode is partially reflected by the reflector and/or lens system. A housing includes a lower seating surface. L-shaped brackets are disposed in the housing each having a base leg and an upstanding leg. The light sources are secured to the upstanding legs. Fasteners are disposed through the base legs at each rotational axis into the seating surface. An arm is disposed in the housing connected to the base legs enabling rotation of each of the light sources. A handle is disposed in the housing that is rotatably mounted at a rotational axis to the seating surface and fastened to the arm such that the optical axes of the light sources are simultaneously adjusted parallel with each other when the handle moves the arm. Heat transfer fins are disposed in thermal communication with the housing. A light transmitting cover can optionally be fastened to a front of the housing.

Specific features described above with regard to the first and second embodiments also apply to the third embodiment. In particular, the light module can be configured and arranged to be mounted to a motor vehicle and can be a daytime running light for the motor vehicle. There can be at least two of the light sources. When the handle moves the arm the longitudinal axis of the handle, and thus the optical axes of the light sources, can be oriented parallel to a longitudinal axis of the motor vehicle.

Many additional features, advantages and a fuller understanding of the invention will be had from the accompanying drawings and the Detailed Description of the Invention that follows. It should be understood that the above Brief Description of the Invention describes the invention in broad terms while the following Detailed Description of the Invention describes the invention more narrowly and presents specific embodiments that should not be construed as necessary limitations of the broad invention as defined in the claims.

### BRIEF DESCRIPTION OF THE DRAWINGS

FIG. 1 is a perspective view of a first aspect of a light module made according to this disclosure;

FIG. 2 is a front view of the light module of FIG. 1;

FIG. 3 is a cross-sectional top view of the light module of FIG. 1;

FIG. 4 is a cross-sectional top view of the light module of FIG. 1, showing movement of the light sources such that the optical axes are parallel;

FIG. 5 is a cross-sectional side view as taken from FIG. 3;

FIG. 6 is a perspective view of the LED light source and bracket of this first aspect of a light module;

FIG. 7 is a perspective view of the light sources and associated structure out of the housing for this first aspect of a light module;

FIG. 8 is a perspective view of a second aspect of a light module made according to this disclosure;

FIG. 9 is a front view of the light module of FIG. 8;

FIG. 10 is a cross-sectional top view of the light module of FIG. 8;

FIG. 11 is a cross-sectional top view of the light module of FIG. 8, showing movement of the light sources such that the optical axes are parallel;

FIG. 12 is a cross-sectional side view as taken from FIG. 10; and

FIG. 13 is a perspective view of the light sources and associated structure out of the housing for this second aspect of a light module.

### DETAILED DESCRIPTION OF THE INVENTION

An optically adjustable light module 10 comprises a plurality of light sources or lamps 12 which are each rotatable about a rotational axis 14 and are configured and arranged to have parallel optical axes 16. Although this section refers to a plurality of light sources it should be appreciated that the light module can include only a single light source (e.g., one LED). Each of the light sources 12 comprises a reflector and/or lens system 18 and a light emitting diode 20 (and associated electronic circuitry on a PCB 21 that includes and secures the LED) positioned such that light from the light emitting diode is partially reflected by the reflector and/or lens system. A housing 22 includes a raised lower seating surface 24. L-shaped brackets 26 are disposed in the housing 22 each having a base leg 28 and an upstanding leg 30. The light sources 12 are secured to the upstanding legs 30. Fasteners 32 are disposed through the base legs 28 at each rotational axis 14 into the seating surface 24. An arm 34 is disposed in the housing 22 connected to the base legs 28 enabling rotation of each of the light sources 12. A handle 36 is disposed in the housing 22 that is rotatably mounted at a rotational axis 38 to the seating surface 24 and fastened to the arm 34 such that the optical axes 16 of the light sources 12 are simultaneously adjusted parallel with each other when the handle 36 moves the arm 34. Heat transfer fins 40 are in thermal communication with the housing (e.g., disposed at a back of the housing 22). The housing 22 can be made of heat conducting material, preferably aluminum.

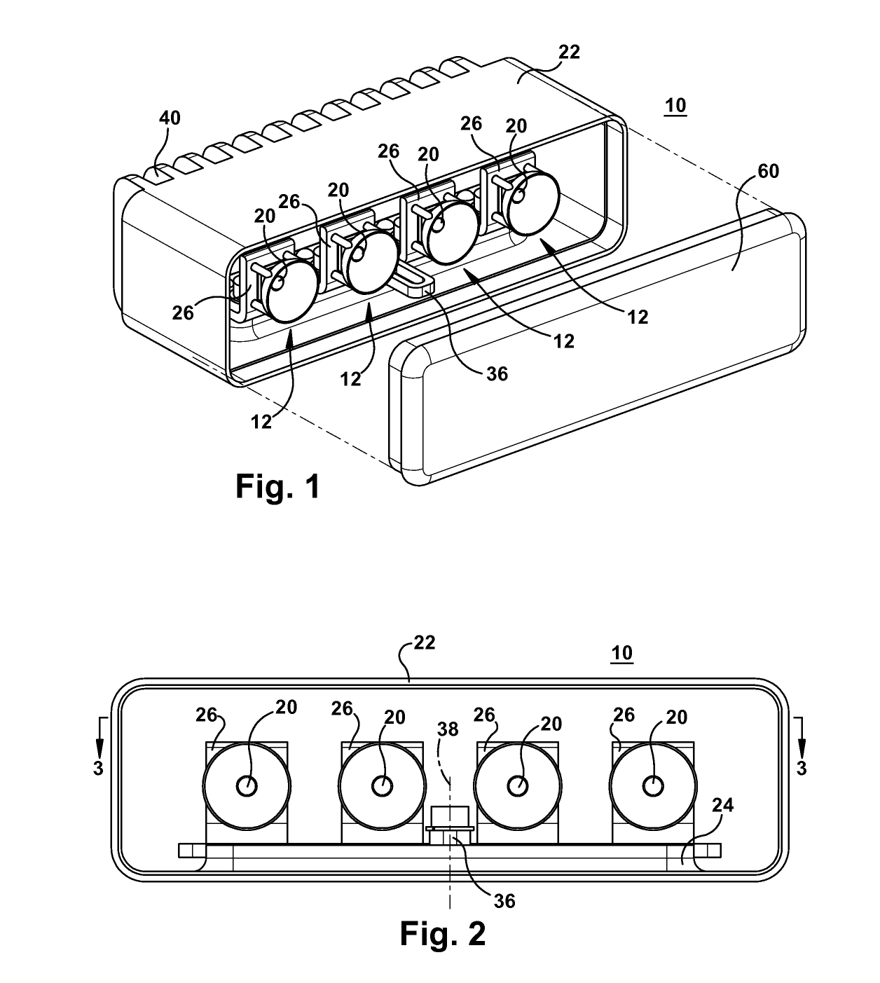

Referring to FIGS. 1-5, in a first specific aspect, the fasteners 32 are disposed between each base leg 28 and the seating surface 24 and fasteners 42 are disposed between each base leg 28 and the arm 34, enabling rotation of each of the light sources such that the optical axes 16 of the light sources are simultaneously adjusted parallel with each other when the arm is moved. Heat transfer can be enhanced by adding thermally conductive materials—gel or foil—between the parts. For example, thermally conductive material can be disposed between the base leg 28 and the seating surface 24 (FIG. 4); and thermally conductive material can be disposed between PCB 21 on which the LED is secured and the upstanding leg 30 (FIG. 5). The arm 34 is located at a back 44 of the interior 46 of the housing 22. Each of the fasteners 42 that connects the base legs 28 to the arm 34 can be pins (e.g., rivets or clinches). The fasteners 32 that extend between the base leg 28 and seating surface 24 can be screws. The handle 36 is rotatably mounted with fastener 50 at the rotational axis 38 to the seating surface 24, and pin 48 (e.g., rivet or clinch) allows movement between the arm 34 and the handle 36. The handle 36 is located in the center of the housing such that the same number of light sources can be disposed on either side of the handle; however, this is not essential. The handle 36 includes axis 62 along its length, which is the axis to which all of the optical axes 16 of the light sources are parallel. The axis 62 is adjusted to be parallel to the car axis during installation on the car. The brackets 26, housing 22 and arm 34 are each designed so that the positioning of central opening 52 in the base leg 28 relative to a corresponding opening in the seating surface and positioning of rear opening 54 of the base leg 28 relative to the corresponding opening in the arm, and spacing apart of these openings for each respective light source 12 along the seating surface 24 of the housing and the arm 34, ensures that the optical axes 16 of all of the light sources are always parallel to each other.

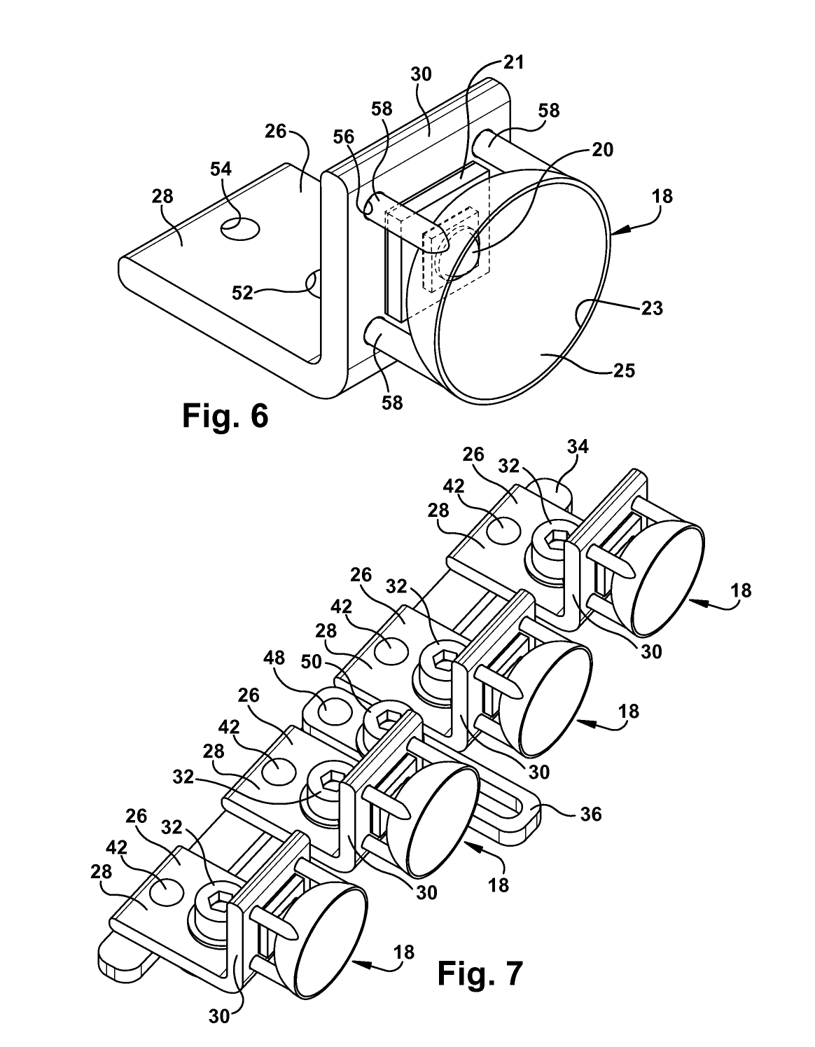

Referring to FIG. 6, the LED 20 is attached to the upstanding leg 30 of the bracket 26 through an opening in that leg. Openings 56 in the upstanding leg are spaced around the opening and receive legs 58 of the hemispherical shaped reflector and/or lens system 18. This system can include a reflector 23 only, a lens 25 only or a reflector 23 and a lens 25 as shown in FIG. 6. The reflector 23 includes a central opening that receives the LED 20. The LED 20 on the PCB 21, and the reflector and/or lens system 18, form the light source or lamp 12. The LED is soldered to the PCB that is connected in a thermally conductive way to the upstanding leg. The driver electronics can be either incorporated into the module or be an external one. Once they are in, a possible place can be the upper back side of the housing, arranged in a way that still allows subsequent optical alignment. The light module is designed in a way that it can be fit to a wide range of car/truck/bus models.

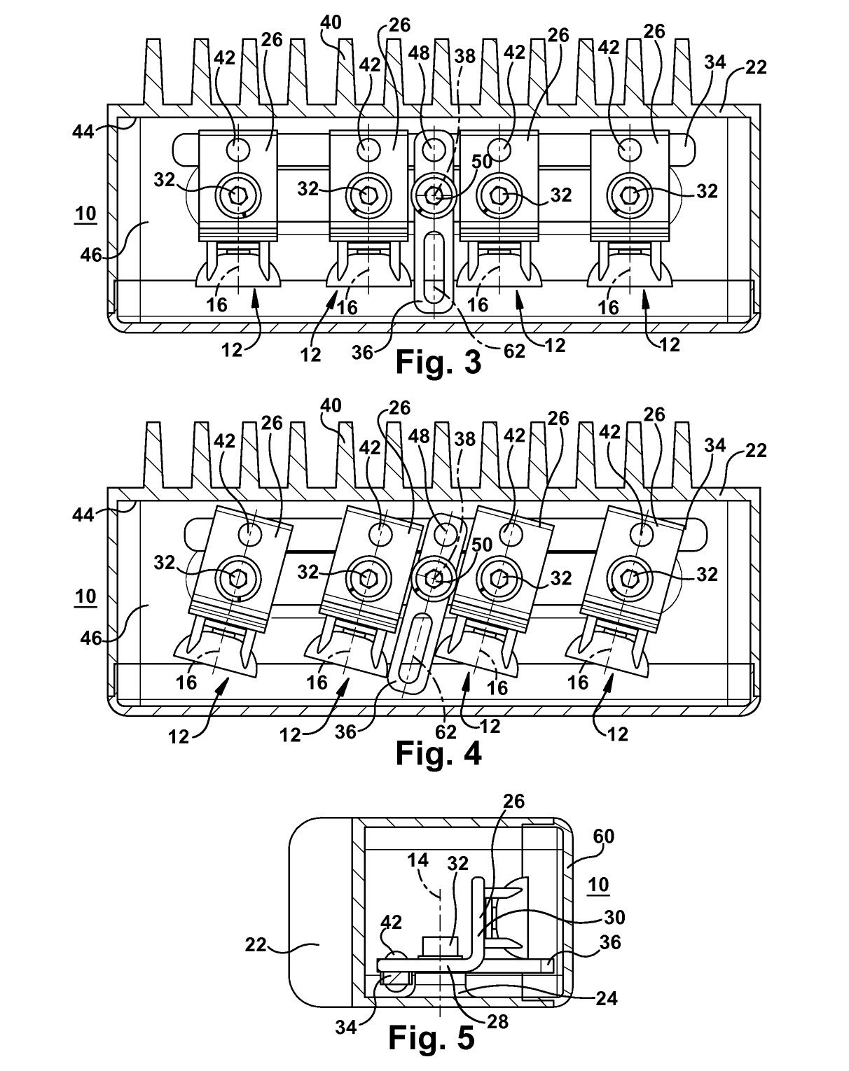

When it is desired to adjust the optical axes 16 of the light sources 12 of this first aspect of the light module 10 design, referring to FIGS. 3 and 4, front light transmitting cover 60 is removed and all five of the screws 32 are loosened. Then, the front portion of the handle 36 is moved left or right, rotating the handle 36 about the axis 38, which moves the arm 34 attached to the handle 36 in the opposite direction, in turn rotating the base legs 28 about the rotational axes 14, thereby simultaneously moving all of the optical axes 16 of the light sources 12 parallel to each other and in a direction that the handle was moved. The module axis 62 or the axis of the handle, is moved to align the optical axes 16 parallel to the motor vehicle axis (the longitudinal axis of the motor vehicle). Once this adjustment has been made, the five screws 32 are tightened, securing the light sources 12 in place. Silicone or other type of sealant can be used around the periphery of the cover to keep out moisture from the light sources. Then, the cover 60 can be snapped or screwed in place against the front of the housing 22. In FIG. 4, the light sources 12 have been moved to the left compared to the light sources 12 in FIG. 3, all the while the optical axes 16 being kept parallel to each other and to the axis 62.

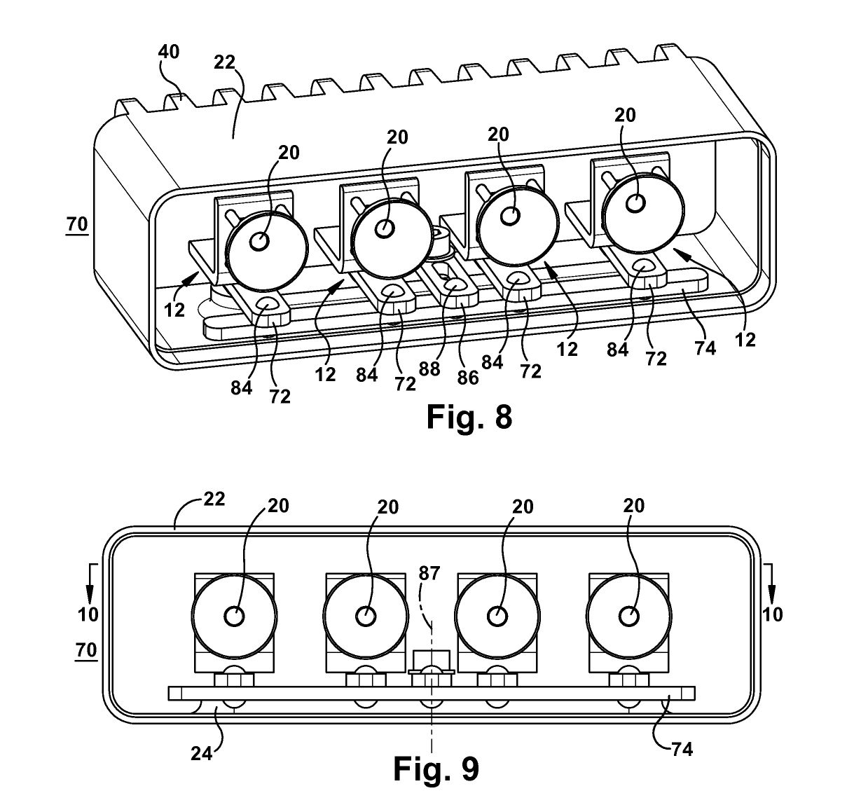

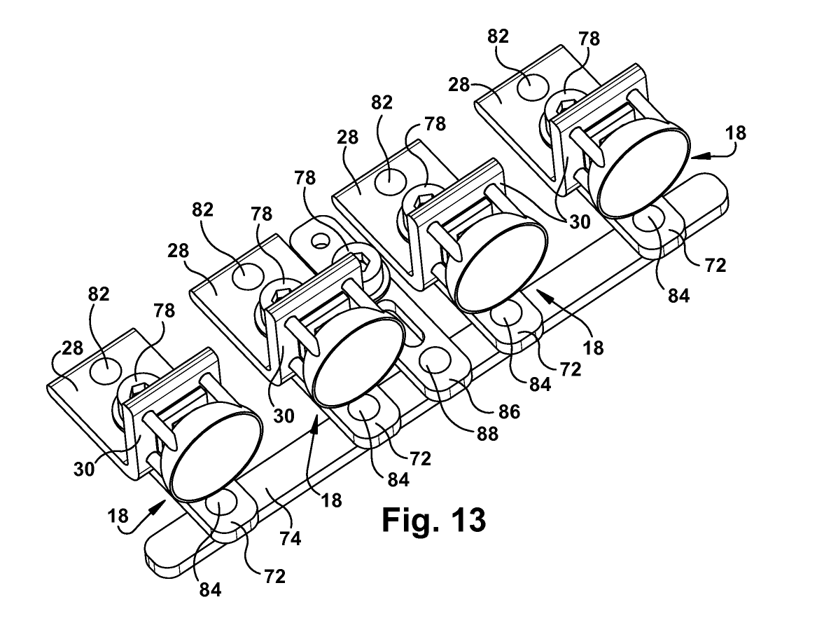

Referring to FIGS. 8-13 in a second specific aspect of a light module design 70, where like parts have been given the same reference numerals as the light module of the first aspect throughout the several views, narrow linkage plates 72 are vertically disposed between the seating surface 24 and the base legs 28 of the brackets 26 (in particular see FIG. 12). The linkage plates 72 extend from arm 74 at the front 76 of the interior of the housing 22 to the base legs 28 at the back 44 of the housing. Fasteners 78 such as screws are disposed at the rotational axes 80 (FIG. 12) through aligned openings in the base legs 28 and linkage plates 72, into the seating surface 24. Fasteners 82 are disposed between each base leg 28 and each linkage plate 72 and fasteners 84 are disposed between each linkage plate 72 and the arm 74, through aligned openings in the base leg 28, arm 74 and linkage plate 72, enabling rotation of each of the light sources 12 such that the optical axes 16 of the light sources are simultaneously adjusted parallel with each other when the arm is moved. Heat transfer can be enhanced by adding thermally conductive materials—gel or foil—between the parts. For example, thermally conductive material can be disposed between the base leg 28 and the linkage plate 72 (FIG. 12) and between the linkage plate 72 and the seating surface 24; and thermally conductive material can be disposed between PCB 21 on which the LED is secured and the upstanding leg 30 (FIG. 6). The fasteners 82 between the base leg 28 and linkage plate 72 and the fasteners 84 between the arm 74 and linkage plate 72 can be pins (e.g., rivets or clinches). The arm 74 is located at a front 76 of the interior of the housing and connects with the pins 82 at the rear of the base legs 28 via the linkage plates 72. A handle 86 is rotatably mounted at a rotational axis 87 to the seating surface 24 via fastener 78, and there is a pin 88 (e.g., a rivet or clinch) between the handle 86 and arm 74. The handle 86 is disposed at a center of the housing, such that the same number of light sources 12 is disposed on either side of the handle; however, this is not essential. The handle 86 includes axis 90 along its length, which is the axis to which all of the optical axes of the light sources are parallel. The axis 90 is moved parallel to the motor vehicle axis.

The brackets 26, housing 22, linkage plate 72 and arm 74 are each designed so that the positioning of the central opening 52 in the base leg 28 relative to the openings in the seating surface 24 and linkage plate 72, the positioning of the rear opening 54 of the base leg 28 relative to the opening in the linkage plate 72, the positioning of the front opening in the linkage plate and opening on the arm 74, and spacing apart of these openings for each respective light source 12 along the seating surface 24 of the housing 22 and the arm 74, ensures that the optical axes 16 of all of the light sources 12 are always parallel to each other.

Referring to FIG. 6, the LED 20 is attached to a center of the upstanding leg 30 of the bracket 26 through a central opening. Openings 56 in the upstanding leg 30 are spaced around the central opening and receive legs 58 of a hemispherical shaped reflector and/or lens system 18. This system can include a reflector 23 only, a lens 25 only or a reflector 23 and a lens 25 as shown in FIG. 10. The LED 20 with its associated PCB 21, and the reflector and/or lens system 18, form the light source or lamp 12. The reflector 23 includes a central opening that receives the LED 20. Driver electronics are attached to the LED 20. The LEDs are connected in series; so there is one common driver.

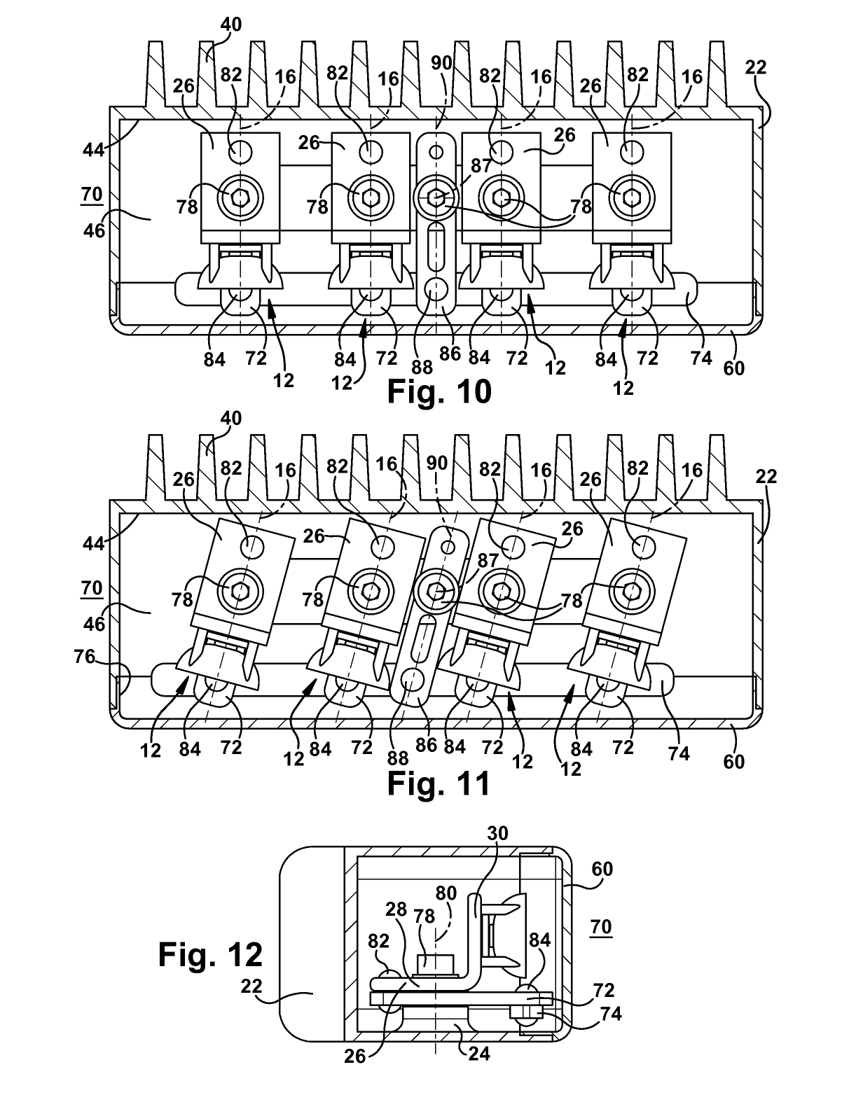

When it is desired to adjust the optical axes 16 of the light sources 12 of this second aspect of the light module design 70, referring to FIG. 10, all five of the screws 78 are loosened. Then, the front portion of the handle 86 is moved left or right, which moves the arm 74 attached to the handle in the same direction as the handle. This movement of the arm 74 moves the linkage plates 72 attached to the arm, in turn rotating the base legs about their rotational axes 78, thereby simultaneously moving all of the optical axes of the light sources 12 parallel to each other in a direction in which the arm has moved. The module axis 90 or the axis of the handle, is moved to align the optical axes 16 parallel to the motor vehicle axis. In FIG. 11, the light sources 12 have been moved to the left compared to their position in FIG. 10, all the while the optical axes 16 being kept parallel to each other and to axis 90. Once this adjustment has been made, the five screws 78 are tightened, securing the light sources 12 in place. Silicone or other type of sealant can be used around the periphery of the cover to keep out moisture from the light sources. Then, the cover 60 can be snapped or screwed in place.

The light module of the first and second design aspects described above, is configured and arranged to be mounted to a motor vehicle (e.g., car, truck or bus), in particular as a daytime running light for the motor vehicle. Any number of light sources may be used in the light module of this disclosure. For example, the plurality of light sources includes at least two of the light sources, in particular, at least four of the light sources.

Many modifications and variations of the invention will be apparent to those of ordinary skill in the art in light of the foregoing disclosure. Therefore, it is to be understood that, within the scope of the appended claims, the invention can be practiced otherwise than has been specifically shown and described.

What is claimed is:

1. An optically adjustable light module comprising:
at least one light source which is rotatable about a rotational axis and has an optical axis; and
an arm that is connected to said light source such that movement of said arm enables said rotation of said light source and adjustment of the optical axis.

2. The light module of claim 1 wherein said light source comprises a light emitting diode.

3. The light module of claim 1 wherein said light source comprises a reflector and/or lens system and a light emitting diode positioned such that light from said diode is reflected by said reflector and/or lens system.

4. The light module of claim 1 wherein said light module includes a housing with heat transfer fins disposed in thermal communication with said housing, said light source and said arm being received in said housing.

5. The light module of claim 1 comprising a seating surface on which a fastener is received at said rotational axis.

6. The light module of claim 5 comprising an L-shaped bracket having a base leg and an upstanding leg, said light source being secured to said upstanding leg, said fastener at said rotational axis extending between said base leg and said seating surface and including a fastener between said base leg and said arm, wherein said fastener between said base leg and said seating surface and said fastener between said base leg and said arm enable rotation of said light source such that the optical axis is adjusted parallel with a longitudinal reference axis when said arm is moved.

7. The light module of claim 5 comprising an L-shaped bracket having a base leg and an upstanding leg, said light source being secured to said upstanding leg, a linkage plate disposed between said seating surface and said base leg, said fastener at said rotational axis extending between said base leg and said seating surface, including a fastener between said base leg and said linkage plate and a fastener between said linkage plate and said arm, wherein said fastener at said rotational axis, said fastener between said base leg and said linkage plate, and said fastener between said linkage plate and said arm enable rotation of said light source such that the optical axis is adjusted parallel with a longitudinal reference axis when said arm is moved.

8. The light module of claim 6 comprising a handle rotatably mounted at a rotational axis to said seating surface, said handle being positioned and arranged such that a longitudinal axis of said handle is aligned with said optical axis, and including a fastener between said handle and said arm.

9. The light module of claim 7 comprising a handle rotatably mounted at a rotational axis to said seating surface, said handle being positioned and arranged such that a longitudinal axis of said handle is aligned with said optical axis, and including a fastener between said handle and said arm.

10. The light module of claim 1 being configured and arranged to be mounted to a motor vehicle.

11. The light module of claim 10 which is a daytime running light for said motor vehicle.

12. The light module of claim 1 comprising at least two of said light sources.

13. The light module of claim 6 comprising a thermally conductive material between said base leg and said seating surface.

14. The light module of claim 7 comprising a thermally conductive material between said base leg and said seating surface.

15. An optically adjustable light module comprising:
a plurality of light sources which are each rotatable about a rotational axis and are configured and arranged to have parallel optical axes, wherein each of said light sources comprises a reflector and/or lens system and a light emitting diode positioned such that light from said light emitting diode is reflected by said reflector and/or lens system;
an arm that is connected to all of said light sources such that movement of said arm enables said rotation of said light sources and the optical axes of the light sources to be simultaneously adjusted parallel with each other;
a housing that receives said light sources and said arm in an interior thereof; and
heat transfer fins disposed in thermal communication with said housing.

16. The light module of claim 15 comprising L-shaped brackets in said housing each having a base leg and an upstanding leg, said light sources being secured to said upstanding legs, fasteners at each said rotational axis extending between each said base leg and said housing, including fasteners between each said base leg and said arm, wherein said fasteners at each said rotational axis and said fasteners between each said base leg and said arm enable rotation of each of said light sources such that the optical axes of said light sources are simultaneously adjusted parallel with each other when said arm is moved.

17. The light module of claim 15 comprising L-shaped brackets in said housing each having a base leg and an upstanding leg, said light sources being secured to said upstanding legs, linkage plates disposed between said housing and base leg, fasteners at each said rotational axis extending between each said base leg and said housing, including fasteners between each said base leg and each said linkage plate and fasteners between each said linkage plate and said arm, wherein said fasteners at each said rotational axis, said fasteners between each said base leg and each said linkage plate and said fasteners between each said linkage plate and said arm enable rotation of each of said light sources such that the optical axes of said light sources are simultaneously adjusted parallel with each other when said arm is moved.

18. The light module of claim 16 comprising a handle positioned and arranged such that a longitudinal axis of said handle is aligned with said optical axes of said light sources, said handle being rotatably mounted at a rotational axis to said housing, and including a fastener between said handle and said arm.

19. The light module of claim 17 comprising a handle positioned and arranged such that a longitudinal axis of said handle is aligned with said optical axes of said light sources, said handle being rotatably mounted at a rotational axis to said housing, and including a fastener between said handle and said arm.

20. The light module of claim 15 being configured and arranged to be mounted to a motor vehicle.

21. The light module of claim 20 which is a daytime running light for said motor vehicle.

22. The light module of claim 15 comprising at least two of said light sources.

23. An optically adjustable light module comprising:
a plurality of light sources which are each rotatable about a rotational axis and are configured and arranged to have parallel optical axes, wherein each of said light sources comprises a reflector and/or lens system and a light emitting diode positioned such that light from said light emitting diode is reflected by said reflector and/or lens system;
a housing including a lower seating surface;
L-shaped brackets disposed in said housing each having a base leg and an upstanding leg, said light sources being secured to said upstanding legs;
fasteners disposed through said base legs at each said rotational axis into said seating surface;
an arm disposed in said housing connected to said base legs enabling rotation of each of said light sources;
a handle disposed in said housing that is rotatably mounted at a rotational axis to said seating surface and fastened to said arm, said handle being positioned and arranged such that a longitudinal axis of said handle is aligned with said optical axes of said light sources, wherein the optical axes of said light sources are simultaneously adjusted parallel with each other when said handle moves said arm; and
heat transfer fins disposed in thermal communication with said housing.

24. The light module of claim 23 being configured and arranged to be mounted to a motor vehicle.

25. The light module of claim 24 which is a daytime running light for said motor vehicle.

26. The light module of claim 23 comprising at least two of said light sources.

27. The light module of claim 24 wherein when the handle moves the arm the longitudinal axis of the handle, and thus the optical axes of the light sources, are oriented parallel to a longitudinal axis of the motor vehicle.
